(19) United States
(12) Patent Application Publication
(10) Pub. No.: US 2021/0271538 A1
(43) Pub. Date: Sep. 2, 2021

(54) SYSTEM AND METHOD FOR DOSSIER CREATION WITH ATTRIBUTE AND METRIC SELECTORS

(71) Applicant: MicroStrategy Incorporated, Tysons Corner, VA (US)

(72) Inventors: Yali GUO, Hangzhou (CN); Xiaodi ZHONG, Hangzhou City (CN); Jingbin ZHANG, Hangzhou City (CN); Jeffrey COURCELLE, Herndon, VA (US); Alejandro Olvera VELASCO, Falls Church, VA (US)

(21) Appl. No.: 16/803,762

(22) Filed: Feb. 27, 2020

(51) Int. Cl. G06F 11/07; G06F 16/904

(52) U.S. Cl. CPC G06F 11/0769; G06F 16/904

(57) ABSTRACT

A method (and system) includes retrieving a dataset from a database, creating a report including a representation of the dataset, the representation of the dataset including a data attribute and a data metric, displaying the report on a graphical user interface and providing a configurable selector adapted to adjust the attribute or the metric. The selector is configurable to target one or multiple representations of data on the report. The selector is configurable to add or replace attributes or metrics to the representation of the dataset.

### BACKGROUND OF THE INVENTION

### Field of the Invention

The present invention generally relates to a method and system for displaying data, and more particularly to a method and system for creating a business analytic report having selector functionality.

### Description of the Related Art

Large databases are common in business today. Indeed, the amount of data available to business organizations today is rapidly increasing. Thus, a challenge for many organizations is to find a way to timely sort and present all relevant information while filtering unnecessary information.

In reporting systems, such as decision support systems, business intelligence systems and on-line analytical processing (OLAP) systems, data sorting and extraction are used to retrieve and present data in an efficient manner. Additionally, the reporting systems provide a means for a user to clearly and creatively present an interactive visualization of the relevant data.

Specifically, dossier building systems and programs or report services documents (RSD) exists in which users can create a dashboard or canvas having one more datasets displayed in different containers. The data sets in each container display an interactive visualization of user selected data (e.g., a table, graph, pie chart, etc.). Particularly, a RSD contains datasets from one or more reports. The data is positioned and formed into a single visual representation of the data that can be presented to a user. The datasets can be displayed in a document or a RSD dashboard. When a user creates a document, report, dossier, visualization, or dashboard, the user specifies the data that appears. Furthermore, the user can control the layout, formatting and grouping of the data.

In current report or dashboard building systems, visualizations are static based on the schema objects by which the visualizations are comprised. Often, designers want to create a single visualization that can cater to multiple end users. Furthermore, end users often have a need to analyze different dimensions of data through various visualizations (e.g., bar or line charts). This, however, means that designers must dedicate more screen space to make these visualizations available to end users, which can make it difficult to present other aspects of the data in an efficient way. For example, to visualize revenue for several time dimensions (e.g., by year, by quarter, by month, etc.), multiple, separate bar charts must be presented to end users, in addition to other visualizations (e.g., grids, KPI's, other charts, etc.), which the user desires to be on the same page of the dossier or document.

Likewise, designers often need to provide flexibility to end users so they are able to toggle, add or remove dimensions (attributes) or metrics being presented in a grid or other visualization in a simple way, without necessarily having to access a full-fledge authoring interface to edit the dossier or document structure.

### SUMMARY OF THE INVENTION

In view of the foregoing and other exemplary problems, drawbacks, and disadvantages of the conventional methods and structures, an exemplary feature of the present invention is to provide a method and system for generating reports, which provides an opportunity for a more dynamic analysis of data and expanding the use cases for dossiers.

In a first, exemplary, non-limiting aspect of the present invention, a method includes retrieving a dataset from a database, creating a report including a representation of the dataset, the representation of the dataset including a data attribute and a data metric, displaying the report on a graphical user interface and providing a configurable selector adapted to adjust the attribute or the metric.

In a second, exemplary, non-limiting aspect of the present invention, a non-transitory computer processor-readable storage medium storing instructions is configured for execution by a computer for retrieving a dataset from a database, creating a report including a representation of the dataset, the representation of the dataset including a data attribute and a data metric, displaying the report on a graphical user interface and providing a configurable selector adapted to adjust the attribute or the metric.

In a third, exemplary, non-limiting aspect of the present invention, a system includes a database storing a dataset, a processor configured to create a report including a representation of the dataset, the representation of the dataset including a data attribute and a data metric and to provide a configurable selector adapted to adjust the attribute or the metric, and a graphical user interface configured to display the report.

In accordance with the above, exemplary aspects of the present invention, a method and system are provided in which the gap between dossier authoring and RSD is bridged by incorporating selector functionality, which currently exists in RSDs but not in dossier building systems and programs, into a dossier building system and program. The inventive method and system includes attribute and metric selectors for all visualization types.

In the context of the present application, attributes and metrics are two entities used to represent data in a dataset. Attributes generally represent dimensions of the data, such as in time attributes (e.g., year, quarter, month, etc.), geographical dimensions (e.g., country, region, state, etc.), product (category, subcategory, item, etc.), etc. Metrics, however, generally represent quantifiable aspects of the data such as revenue, cost, product count, etc.

An attribute or metric selector can be used to toggle, add or remove dimensions or attributes in the visualization(s), or to toggle, add or remove metrics in the visualization(s), but cannot be used to switch attributes and metrics at the same time. In the present invention, however, dossier and document designers can use two separate selectors, including, for example, an attribute selector and a metric selector, to allow end users to toggle, add or remove attributes and metrics from the visualization(s), respectively.

These selectors can be configured similarly to in-canvas filters and be targeted to multiple visualizations on a single page. In-canvas filters are selectors that allow filtering the data in the targeted visualization(s), whereas Attribute or Metric selectors are selectors that allow toggling, switching, adding or removing Attributes or Metrics in the targeted visualization.

Although both selector types allow users to interact with visualizations in the dossier, they serve different purposes. In-canvas filters effectively allow end-users to filter and narrow down the data being presented in the visualizations (e.g., targeted visualizations), so that they can focus in the data the user is concerned with (e.g., only select two specific product categories or visualize data from a specific year). Attribute and metric selectors, on the other hand, do not apply any filtering to the data, but instead allow the user(s) to select the dimensions or values/metrics they want to visualize. For example, the user can switch from visualizing revenue by year to visualizing revenue by month, or, instead of visualizing revenue, the user can visualize cost.

For migrating users from a RSD system to dossier building systems and programs, the present invention makes up for a previously missing, crucial functionality gap for users that are used to utilizing selectors, which have not previously been available in dossier building systems and programs. Furthermore, selectors can also provide an opportunity for a more dynamic analysis of data, expanding the use cases for dossiers and driving adoption of the use of enterprise-level dossiers. Specifically, a dossier designer will be able, with the present invention, to configure attribute and metric selectors within the dossier authoring interface to allow end users (e.g., analysts and business users) a more dynamic analysis in the end user interface (e.g., in both web and mobile interfaces). This is possible as the attribute and metric selectors are available in both the authoring and end user interfaces/views.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system 100 according to certain exemplary embodiments of the present invention;

FIG. 2 illustrates a system 200 according to certain exemplary embodiments of the present invention;

FIG. 3 illustrates a method 300 according to certain exemplary embodiments of the present invention;

FIG. 4 illustrates a method 400 according to certain exemplary embodiments of the present invention;

FIG. 5 illustrates an exemplary report generated by the system and method of the present invention;

FIGS. 5-18E illustrate exemplary reports generated by the system the system and method of the present invention illustrating various features of the the system and method of the present invention; and

FIG. 19 illustrates exemplary styles for the attribute/metric selectors in accordance with certain exemplary embodiments of the system and method of the present invention.

### DETAILED DESCRIPTION OF EXEMPLARY

### Embodiments of the Invention

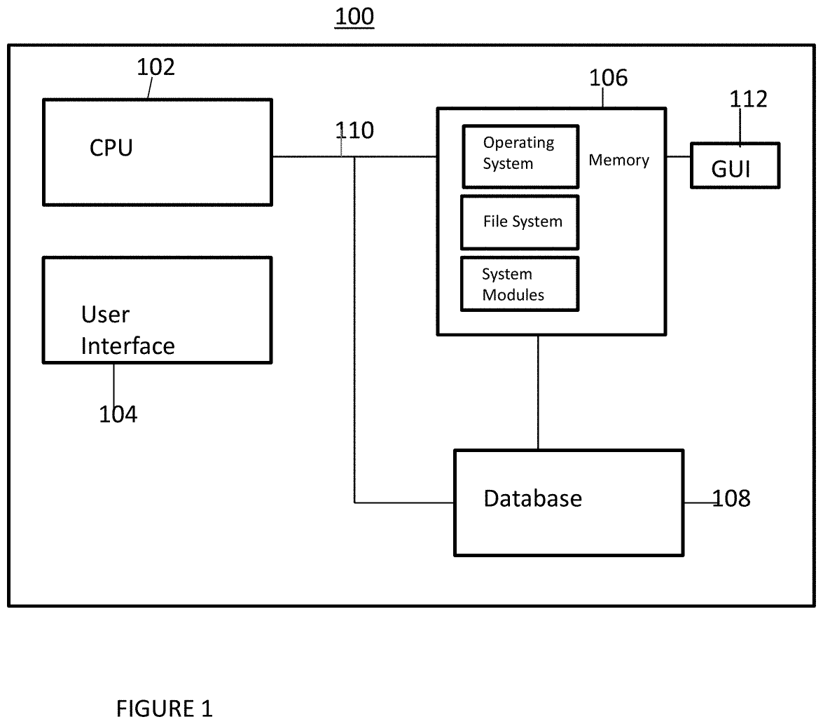

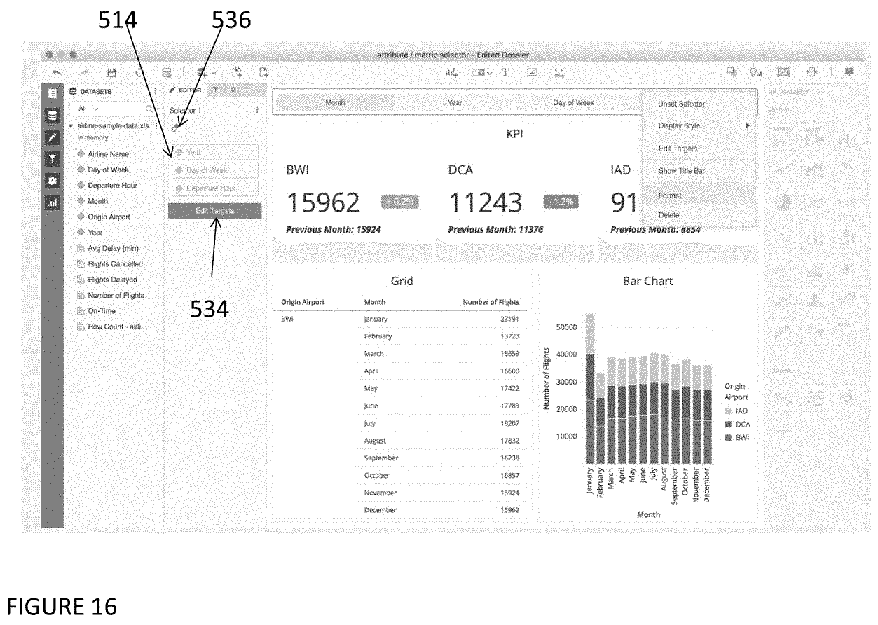

Referring now to the drawings, and more particularly to FIGS. 1-18C, there are shown exemplary embodiments of the method and structures according to the present invention.

FIG. 1 is a block diagram illustrating a system 100 according certain exemplary aspects of the invention. Specifically, the system 100 is configured to create reports/documents/dossiers including a visualization of one or more datasets. As is illustrated in FIG. 1, the system 100 includes a CPU 102 having a user interface 104 (e.g., mouse, keyboard, touch screen, etc.). The CPU 102 is connected to a memory 106, storing an operating system, file system and computer system modules configured to perform the method of the present invention (e.g., process data and generate reports), and a database 108, storing one or more datasets, by a system bus 110. The system 100 includes a graphical user interface (GUI) 112 configured to receive and display a generated report.

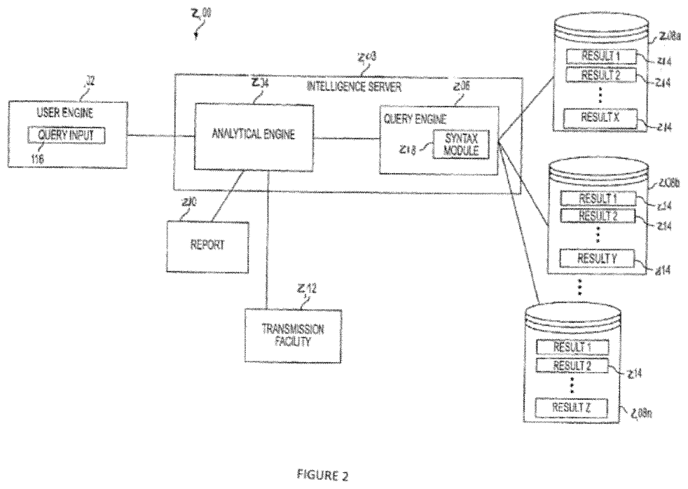

FIG. 2 further defines elements of the system in accordance with certain exemplary embodiments of the present invention. Specifically, FIG. 2 is a block diagram illustrating a system 200 by which a variety of data resources may be accessed for business analytic, report generation and other intelligence purposes according to an embodiment of the invention. According to certain exemplary embodiments of the invention, the system 200 may comprise an online analytical processing (OLAP) decision support system (DSS). In particular, FIG. 2 may comprise a portion of the Microstrategy platform, which provides a preferred system in which the present invention may be implemented.

In general, through using the system 200 of the invention, analysts, managers and other users may query or interrogate a plurality of databases or database arrays to extra demographic, sales and/or financial data and information and other patterns from records stored in such databases or database arrays to identify strategic trends. The strategic trends may not be discernable without processing the queries and treating the results of the data extraction according to the techniques performed by the systems and methods of the invention. This is in part because the size and complexity of some data portfolios stored in such databases or database arrays may mask those trends.

In addition, the system 200 may enable the creation of reports or services that are processed according to a schedule. Users may then subscribe to the service, provide personalization criteria and have the information automatically delivered to the user.

As illustrated in FIG. 2, a business, government, user or other organization may access the resources of the system 200 using a user engine 202. The user engine 202 may include a query input module 216 to accept a plurality of searches, queries or other requests, via a query box or on a graphical user interface (GUI) or another similar interface. The user engine 202 may communicate with an analytical engine 204. The analytical engine 204 may include a set of extensible modules to run a plurality of statistical analyses, to apply filtering criteria, to perform a neural net technique or another technique to condition and treat data extracted from data resources hosted in the system 200, according to a query received from the user engine 202.

The analytical engine 204 may communicate with a query engine 206, which in turn interfaces to one or more data storage devices 208a, 208b . . . 208n (where n is an arbitrary number). The data storage devices 208a, 208b . . . 208n may include or interface to a relational database or another structured database stored on a hard disk, an optical disk, a solid state device or another similar storage media. When implemented as databases, the data storage devices 208a, 208b . . . 208n may include or interface to, for example, an OracleTM relational database such as sold commercially by Oracle Corporation, an IBM Informix™ database, a Database 2 (DB2) database, a Teradata database, or another data storage device or query format, platform or resource such as an OLAP format, a Standard Query Language (SQL) format, a storage area network (SAN), or a Microsoft Access™ database. It should be understood that while data storage devices 208a, 208b . . . 208n are illustrated as a plurality of data storage devices, in some embodiments the data storage devices may be contained within a single database or another single resource.

Any of the user engine 102, the analytical engine 104 and the query engine 106 or other resources of the system 100 may include or interface to or be supported by computing resources, such as one or more associated servers. When a server is employed for support, the server may include, for instance, a workstation running a macOS operating system, a Windows™ 10 operating system, a Unix operating system, or a a Linux operating system, or a server running an Oracle Solaris™ operating system, a macOS, Red Hat, Ubuntu or other Linux-based server operating systems. According to one embodiment of the present invention, the analytical engine 304 and the query engine 306 may comprise elements of an intelligence server 303.

The data storage devices 208a, 208b . . . 208n may be supported by a server or another resource and may, in some embodiments, include redundancy, such as a redundant array of independent disks (RAID), for data protection. The storage capacity of any one or more of the data storage devices 208a, 208b . . . 208n may be of various sizes, from relatively small datasets to very large database (VLDB)-scale datasets, such as warehouses holding terabytes of data or more. The fields and types of data stored within the data storage devices 208a, 208b . . . 208n may also be diverse, and may include, for instance, financial, personal, news, marketing, technical, addressing, governmental, military, medical or other categories of data or information.

The query engine 206 may mediate one or more queries or information requests from those received from the user at the user engine 202 to parse, filter, format and otherwise process such queries to be submitted against the data contained in the data storage devices 208a, 208b . . . 208n. Thus, a user at the user engine 202 may submit a query requesting information in SQL format, or have the query translated to SQL format. The submitted query is then transmitted via the analytical engine 204 to the query engine 206. The query engine 206 may determine, for instance, whether the transmitted query may be processed by one or more resources of the data storage devices 208a, 208b . . . 208n in its original format. If so, the query engine 206 may directly transmit the query to one or more of the resources of the data storage devices 208a, 208b . . . 208n for processing.

If the transmitted query cannot be processed in its original format, the query engine 206 may perform a translation of the query from an original syntax to a syntax compatible with one or more of the data storage devices 208a, 208b . . . 208n by invoking a syntax module 218 to conform the syntax of the query to standard SQL, DB2, IBM Informix™ Teradata formats or to other data structures, syntax or logic.

The query engine 206 may likewise parse the transmitted query to determine whether it includes any invalid formatting or to trap other errors included in the transmitted query, such as a request for sales data for a future year or other similar types of errors. Upon detecting an invalid or an unsupported query, the query engine 206 may pass an error message back to the user engine 202 to await further user input.

When a valid query such as a search request is received and conformed to a proper format, the query engine 206 may pass the query to one or more of the data storage devices 208a, 208n . . . 208n for processing. In some embodiments, the query may be processed for one or more hits against one or more databases in the data storage devices 208a, 208b . . . 208n. For example, a manager of a restaurant chain, a retail vendor or another similar user may submit a query to view gross sales made by the restaurant chain or retail vendor in the State of New York for the year 1999. The data storage devices 208a, 208b . . . 208n may be searched for one or more fields corresponding to the query to generate a set of results 214.

Although illustrated in connection with each data storage device 208 in FIG. 1, the results 214 may be generated from querying any one or more of the databases of the data storage devices 208a, 208b . . . 208n, depending on which of the data resources produce hits from processing the search query. In some embodiments of the system 200 of the invention, the results 214 may be maintained on one or more of the data storage devices 208a, 208b . . . 208n to permit one or more refinements, iterated queries, joinders or other operations to be performed on the data included in the results 214 before passing the information included in the results 214 back to the analytical engine 204 and other elements of the system 200.

When any such refinements or other operations are concluded, the results 214 may be transmitted to the analytical engine 204 via the query engine 206. The analytical engine 204 may then perform statistical, logical or other operations on the results 214 for presentation to the user. For instance, in the State of New York reached $1 M in sales at the earliest time in the year 2019. Or, the user may submit a query asking for an average, a mean and a standard deviation of an account balance on a portfolio of credit or other accounts.

The analytical engine 204 may process such queries to generate a quantitative report 210, which may include a table or other output indicating the results 214 extracted from the data storage devices 208a, 208b . . . 208n. The report 210 may be presented to the user via the user engine 202, and, in some embodiments, may be temporarily or permanently stored on the user engine 202, a client machine or elsewhere, or printed or otherwise output. In some embodiments of the system 200 of the invention, the report 210 or other output may be transmitted to a transmission facility 212, for transmission to a set of personnel via an email, an instant message, a text-to-voice message, a video or via another channel or medium. The transmission facility 212 may include or interface to, for example, a personalized broad-cast platform or service. Similarly, in some embodiments of the invention, more than one user engine 202 or other client resource may permit multiple users to view the report 210, such as, for instance, via a corporate intranet or over the Internet using a Web browser. Various authorization and access protocols may be employed for security purposes to vary the access permitted users to such report 210 in such embodiments.

Additionally, an administrative level user may create a report as part of a service. Subscribers/users may then receive access to reports through various types of data delivery devices including telephones, email, wireless communication devices, mobile phones, tablets, and many others. In addition, subscribers may specify trigger conditions so that the subscriber receives a report only when that condition has been satisfied. The platform of FIG. 2 may have many other uses, as described in detail with respect to the MicroStrategy platform, the details of which will be appreciated by one of ordinary skill in the reporting and decision support system art.

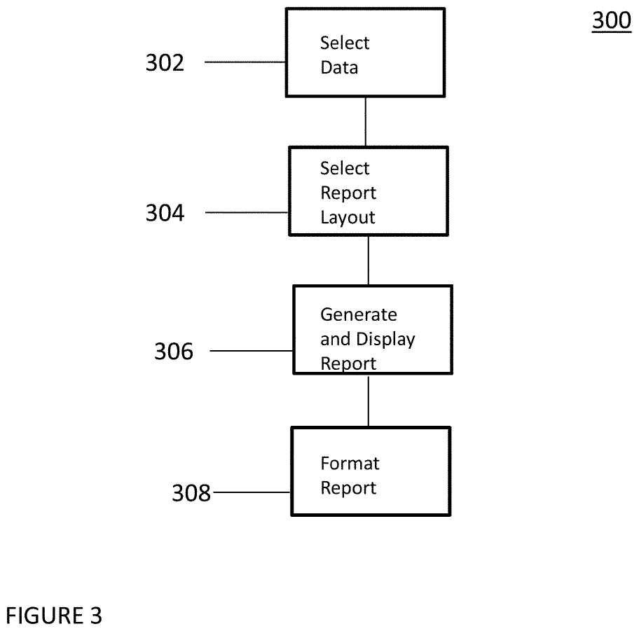

FIG. 3 illustrates a basic flow chart of a method 300 for generating a report according to certain exemplary embodiments of the invention. At step 302, the system receives a request from a user for selecting one or more specific datasets from the database/data storage devices. At step 304, the user selects a report layout 304. At step 306, the system generates and displays the report based on the selected layout and selected dataset(s). At step 308, the user formats the layout and specific containers included in the layout.

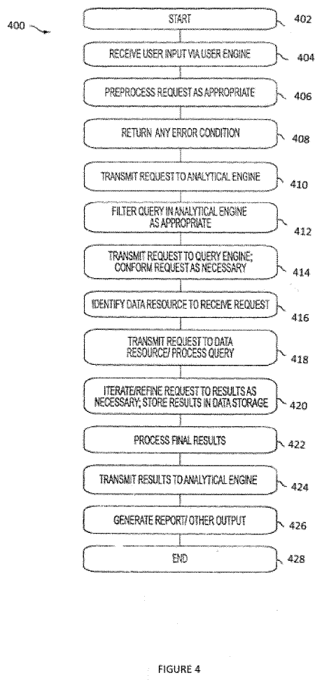

The specific steps performed in a method 400 for generating a report according to certain exemplary embodiments of the present invention are illustrated in the flowchart of FIG. 4. In step 402, the method 400 begins. In step 404, the user may supply input, such as a query or a request for information, via the user engine 202. In step 406, the user input query may be preliminarily processed, for instance, to determine whether it includes valid fields and for other formatting and error-flagging issues. In step 408, any error conditions may be trapped and an error message presented to the user, for correction of the error conditions. In step 410, if a query is in a valid format, the query may then be transmitted to the analytical engine 204.

In step 412, the analytical engine 204 may further process the input query as appropriate to ensure the intended results 214 may be generated to apply the desired analytics. In step 414, the query engine 206 may further filter, format and otherwise process the input query to ensure that the query is in a syntax compatible with the syntax of the data storage devices 208a, 208b . . . 208n. In step 416, one or more appropriate databases or other resources within the data storage devices 208a, 208b . . . 208n may be identified to be accessed for the given query.

In step 418, the query may be transmitted to the data storage devices 208a, 208b . . . 208n and the query may be processed for hits or other results 214 against the content of the data storage devices 208a, 208b . . . 208n. In step 420, the results 214 of the query may be refined, and intermediate or other corresponding results 214 may be stored in the data storage devices 208a, 208b . . . 208n. In step 422, the final results 214 of the processing of the query against the data storage devices 208a, 208b . . . 208n may be transmitted to the analytical engine 204 via the query engine 206. In step 424, a plurality of analytical measures, filters, thresholds, statistical or other treatments may be run on the results 214. In step 426, a report 210 may be generated. The report 210, or other output of the analytic or other processing steps, may be presented to the user via the user engine 202. In step 428, the method 400 ends.

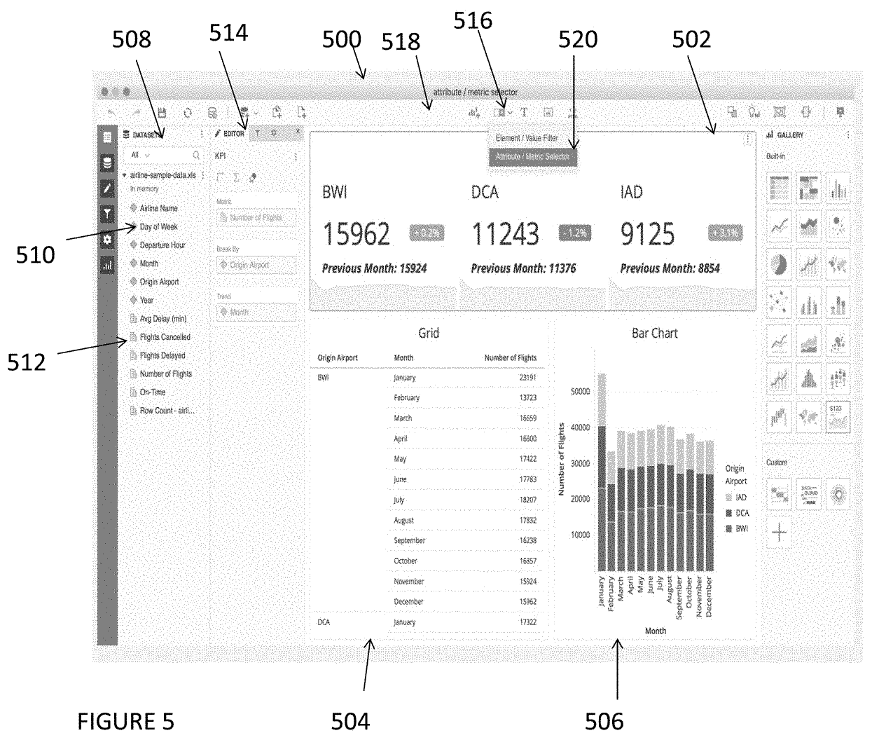

FIG. 5 illustrates a report 500 generated by the system and method according to certain exemplary embodiments of the present invention. As illustrated in FIG. 5, the report 500 includes one or more data containers. In the exemplary embodiment illustrated in FIG. 5, the report 500 includes a container 502 including a KPI (key performance indicator), a container 504 including a grid and a container 506 including a bar chart. The exemplary report 500 in FIG. 5 presents data related to the number of flights per month in several airports. Each of the containers 502, 504 and 506 initially present the number of flights per month a three different airports (e.g., BWI, DCA and IAD), each in their own specific visualization.

The report 500 also provides a dataset list 508. The dataset list 508 lists one or more selectable attributes 510 and one or more selectable metrics 512. As is illustrated in FIG. 5, the attributes 510 and the metrics 512 are identified by a distinct icon. The report 500 also provides an editor panel 514, which indicates, for a selected container, a currently displayed metric and a currently displayed attribute. For example, in FIG. 5, the KPI container 502 is selected and listed in the editor panel 514. The editor panel also identifies that the current metric displayed in the KPI container 502 is “Number of Flights” and the current attributes are “Origin Airport” and “Month.”

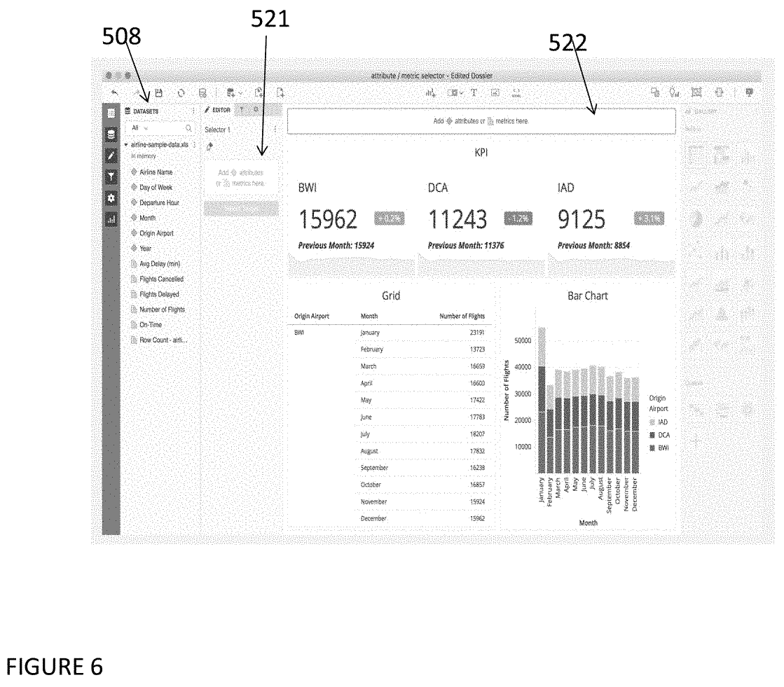

When a user wishes to view a different metric or attribute, the user must select the filter icon 516 included in the report tool bar 518. When the user selects the filter icon 516, the user is provided with a filter drop down menu 520 to select “Element/Value Filter” (i.e., in-canvas filter) or “Attribute/Metric Selector.” As is illustrated in FIG. 6, when the user selects the option for “Attribute/Metric Selector,” an attribute/metric selector 522 is displayed on the report 500. Additionally, an attribute/metric selector dropzone 521 will be displayed in the editor panel 514. A user may add attributes and/or metrics into the dropzone 521. Specifically, the user may add one or more of the metrics and/or attributes listed in dataset list 508.

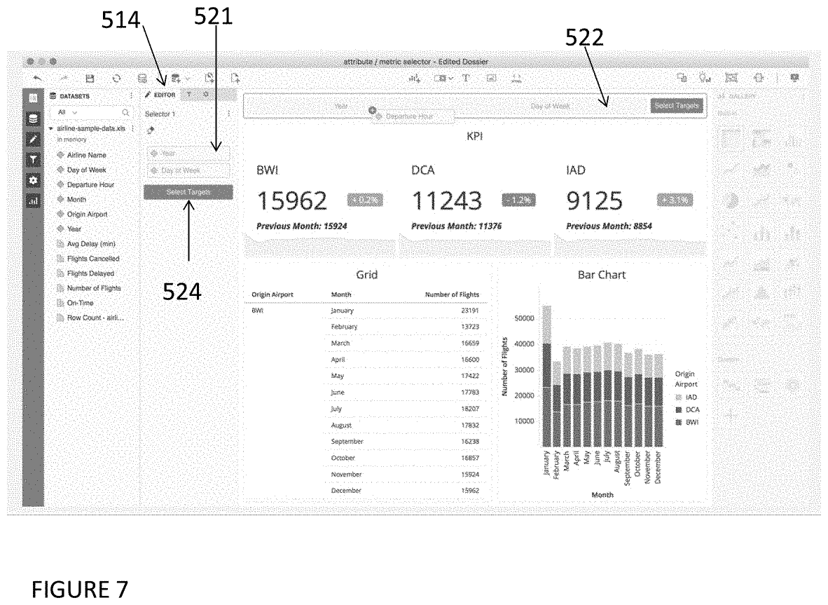

For example, in the exemplary report listed in FIG. 7, the user has selected the attributes related to “Year,” “Day of Week” and “Departure Hour” and added these attributes into the dropzone 521. Specifically, the user can drag and drop attributes and/or metrics from the dataset list 508 into the dropzone 521 available in the editor panel 514. These attributes and/or metrics will also be displayed in the container of the attribute or metric selector 522. Additionally, attributes and metrics can also be dragged directly into a container of the attribute or metric selector 522. Once the user adds the attributes/metrics into the dropzone, a “Select Target” option 524 is displayed in the in the editor panel 514. The “Select Target” option 524 appears automatically in the container of the attribute or metric selector to prompt the dossier designer/author to select the “Select Targets” option 524 and, thus, be able to select the specific visualization(s) to be targeted. The “Select Target” option 524 allows the user to select one or more of the data containers as a target for editing.

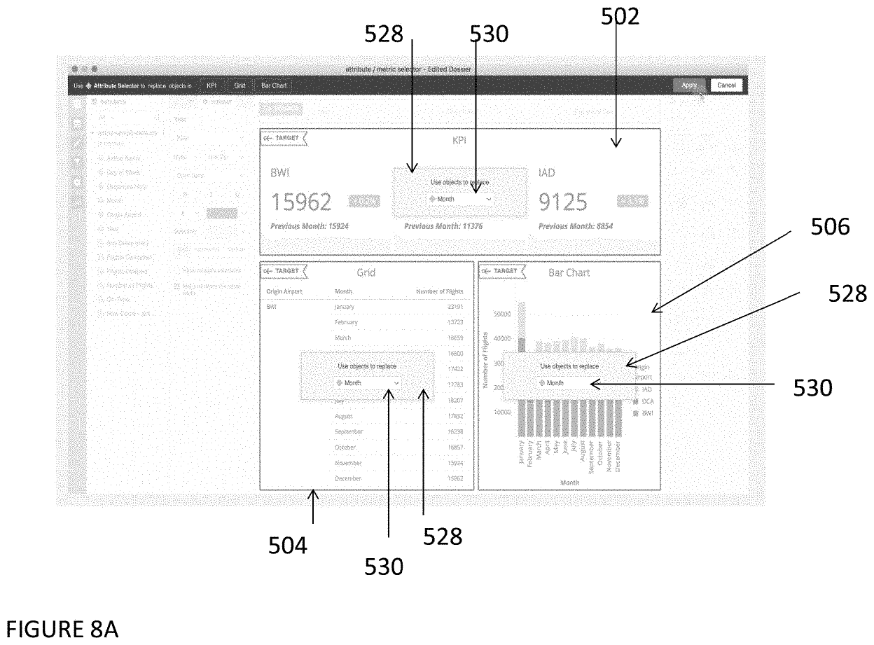

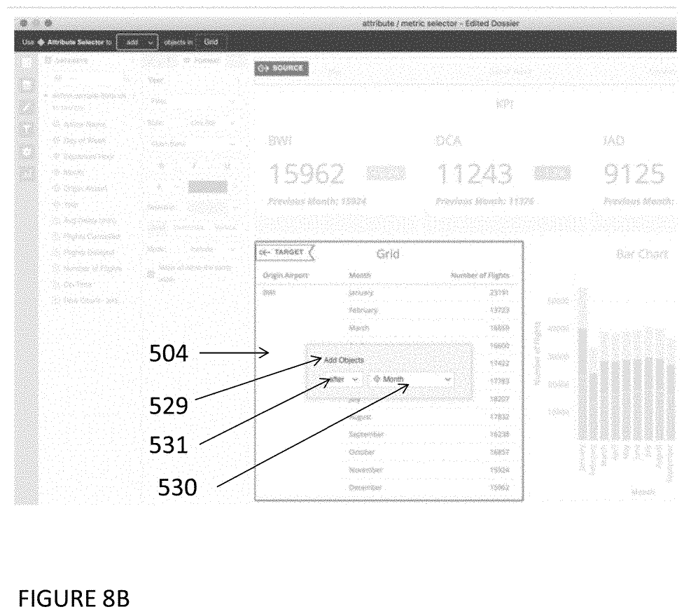

As is illustrated in FIG. 8A, when the user selects the “Select Target” option 524, each of the data containers is highlighted. Additionally, an “use object to replace” option/box 528 will appear in each of the data containers. The “use object to replace” option/box 528 includes a dropdown menu 530 for selecting an attribute and/or metric to replace in one or more of the data containers. In the current example, all three data containers 502, 504 and 506 (i.e., target objects) had the same attribute (i.e., “Month”). Thus, in the “use object to replace” option/box (selector) 528, one or more options is listed; in this case “Month.” If the attributes/metrics in each of the target objects (data containers) are not the same, then selector 522 would be listed as “Default.” In the current example, all three data containers 502, 504 and 506 (i.e., target objects) had the same attribute “Month” selected in the “use objects to replace” window 528. In such scenario, “Month” as the Replace Object will appear in left side of the selector list 522.

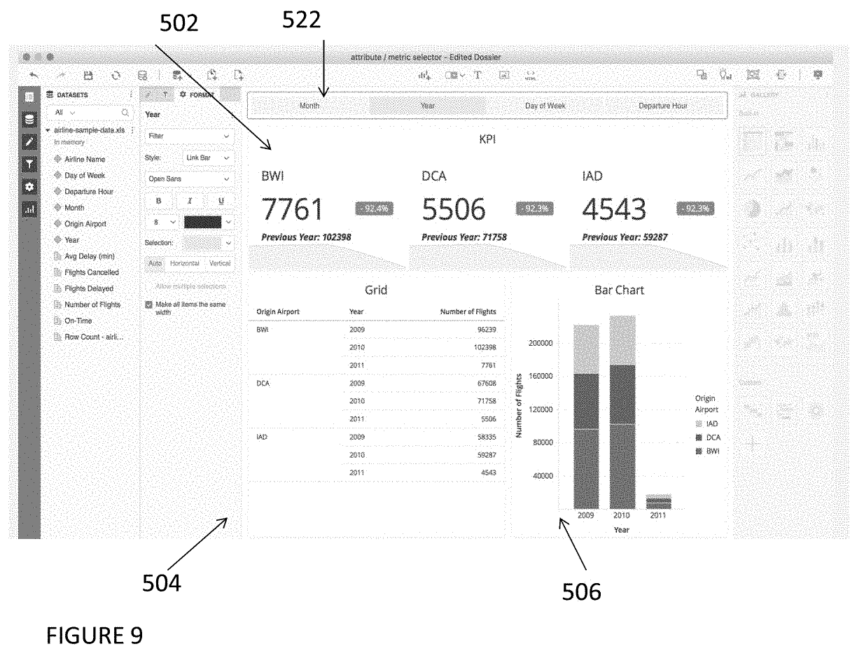

FIG. 9 illustrates a case in which the user has elected to change the attribute from “Month” to “Year.” The option for “Year” in the container of the attribute/metric selector 522 is highlighted. Additionally, the dataset in each of the containers 502, 504 and 506 is updated to visualize the number of flights per year instead of the previous number of flights per month.

In accordance with certain exemplary aspects of the invention, the selector 528 can be applied to a specific visualization (data container) within a page or all of the visualizations (data containers) within the page. The selector 528 adjusts the attribute(s) and/or metric(s) included within the visualization(s). The present invention includes selectors for attributes and metrics for all visualization types (e.g., KPI, grids, bar charts, etc.). The present invention includes at least the following two types of selectors. First, replace selectors are configured with a single selection from “n” attributes and/or metrics to replace a specific target within the dossier. The replace selectors are available for both grids (a specific column within the grid) and visualizations (a specific drop zone delineation, i.e., horizontal axis, vertical axis, break-by, color-by, etc.). Second, multi-select selectors are configured with any combination of “n” attributes and/or metrics to be included within the grid template. The multi-select selectors allow the user to add an additional metric and/or attribute to an existing target, as opposed to the replace selector, which only allows a user to replace the existing metric and/or attribute with a new metric and/or attribute. When the “allow multiple selection” is enabled, the user is able to replace more than one attribute or metric to an existing target, which is different from the single selection. The multi-select selectors can only be used for grid containers and not visualizations.

FIG. 8B illustrates an additional feature of the selector. Specifically, when the user is using a multi-selection (add on) selector, an “add objects” option/box 529 will appear in the grid container 504. The “add objects” option/box 529 includes the dropdown menu 530 for selecting an attribute and/or metric, as noted above, and also includes a dropdown menu 531 for selecting the positon of the added attribute(s)/metric(s). Specifically, the user can select whether the new attribute(s)/metric(s) will be placed before or after the existing attribute(s)/metric(s).

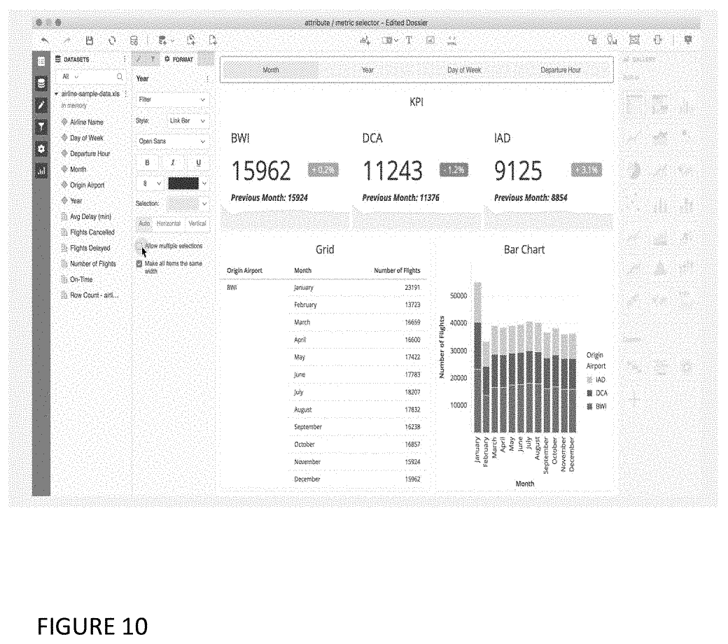

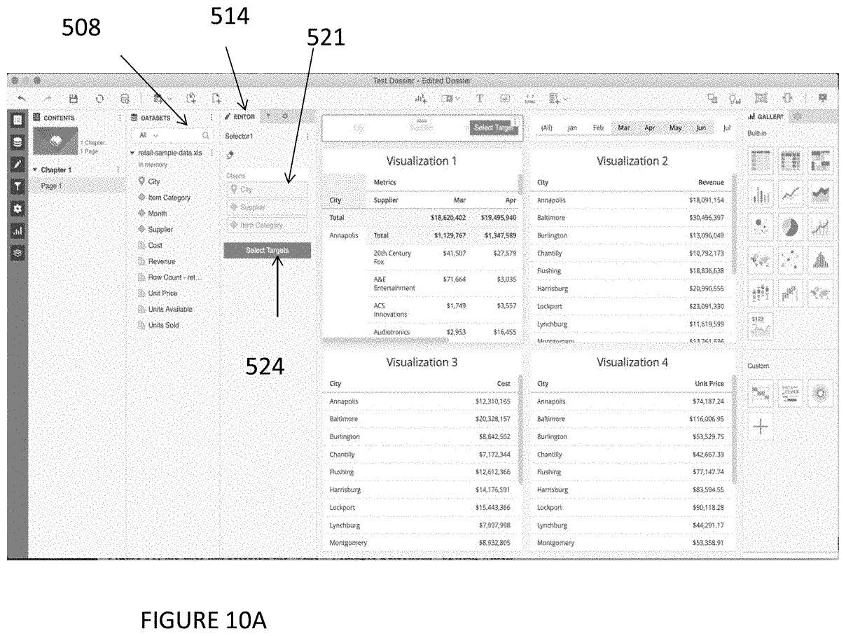

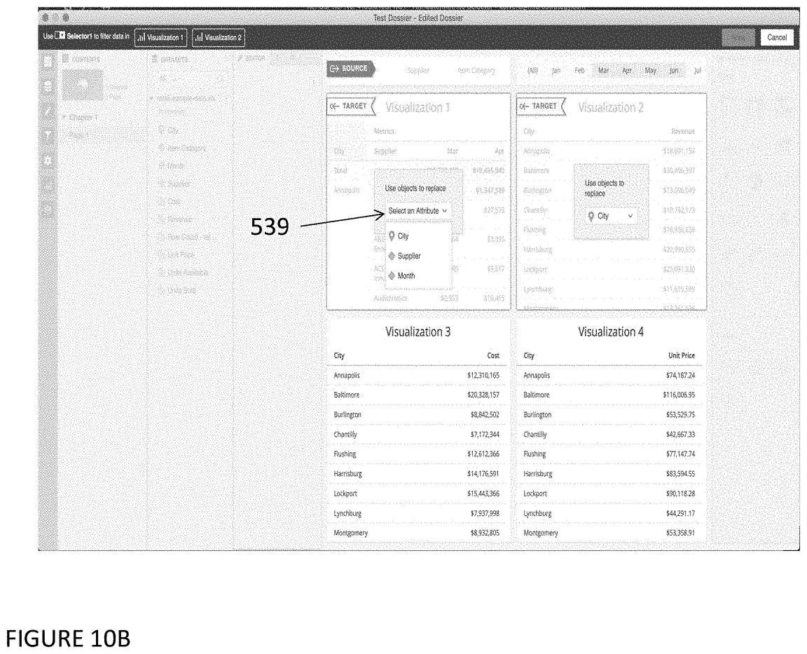

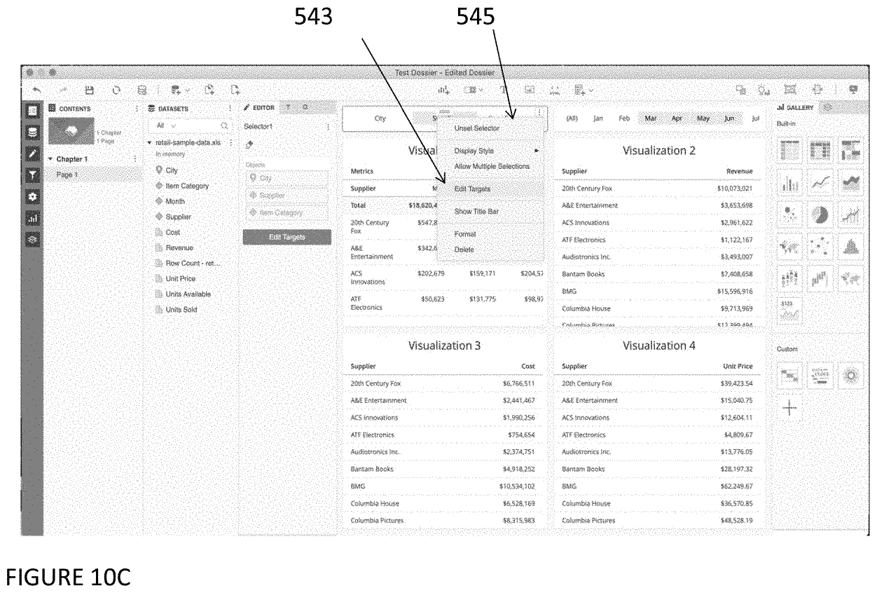

For example, in FIG. 10, the selector has only targeted grids. When creating a new attribute or metric selector, and populating it with attributes or metrics respectively, the user can then select the target visualizations by clicking on/selecting the “Select Targets” option 524, which is presented to the user automatically, and then clicking on/selecting the visualization container(s) that the user wants to target (e.g., see FIG. 10A). The “Select Targets” option 524 will appear automatically after the objects are dragged and dropped from the datasets panel into the dropzone 521 in the editor panel 514. After user clicks on the “Select Targets” option 524, the user can then click on any visualization container that the user wants to select as a target. When clicking on a visualization container, an additional window 539 appears, as illustrated in FIG. 10B, in the center of said visualization container, which allows the user to specify which object of the visualization should be switched when the end user interacts with the attribute or metric selector.

Additionally, the user(s) can modify the targets by clicking on the “Edit Targets” option 543 in the selector's context menu 545. This will go back to the “target selection” mode, which allows users to click visualizations to select or unselect them as targets of the attribute or metric selector (e.g., see FIG. 10C).

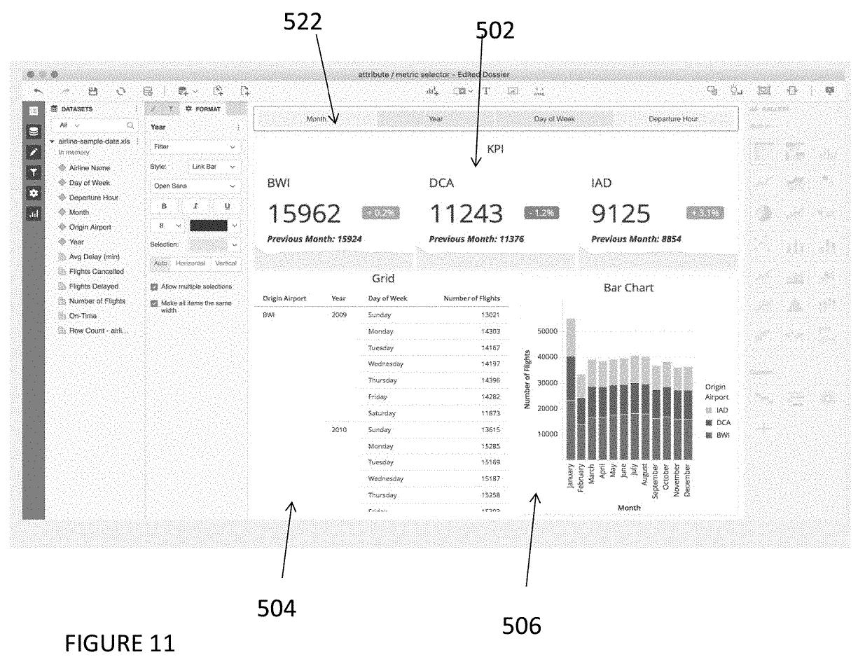

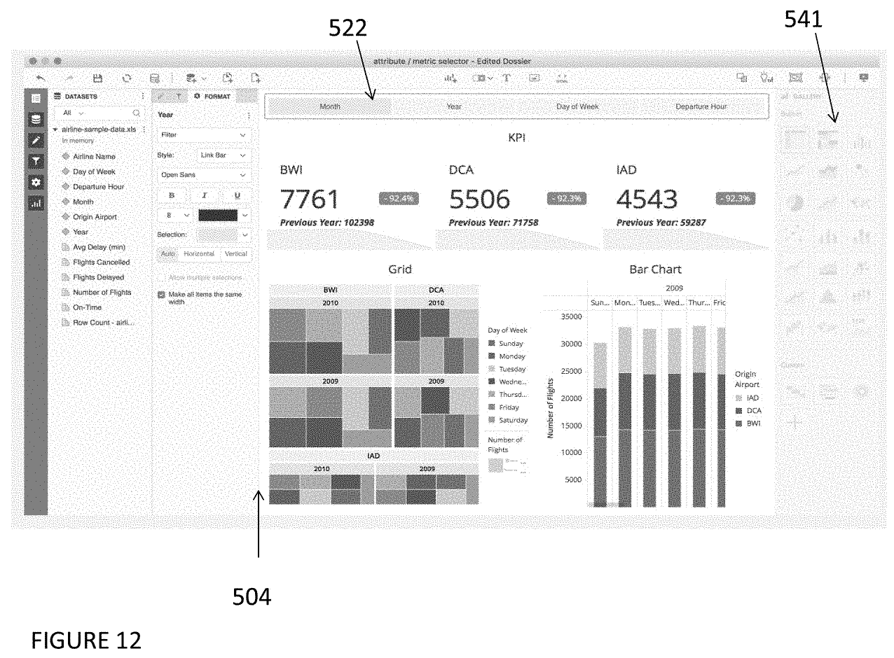

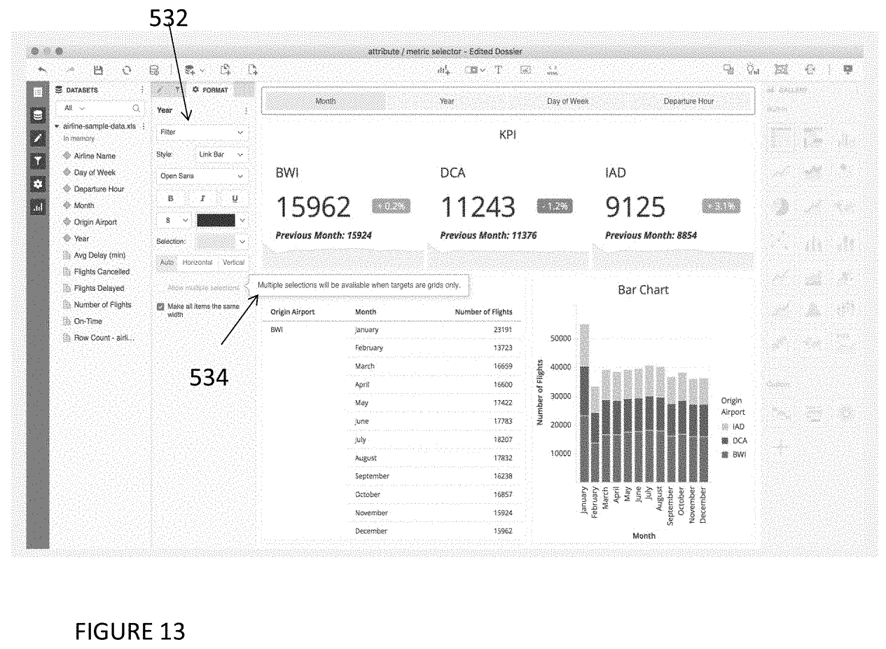

Thus, since only grids are targeted, the user can make multiple selections. In the editor panel 514, an option is provided to “Allow Multiple Selections.” As is illustrated in FIG. 11, the user has selected the “Allow Multiple Selections” option, which allows the user to select multiple attributes. As is illustrated, the user, in this exemplary case, has selected “Year” and “Day of Week,” both of which are highlighted in the attribute/metric selector 522. Furthermore, only the data container 504 including the grid is updated. That is, the KPI container 502 and the bar chart container 505 both still display the initial “Month” attribute. The grid container 504, however, has been updated to display both the “Year” and “Day of Week” attributes. Additionally, as is illustrated in FIG. 12, the user can freely change the display in a data container from a grid to a visualization. For example, the user can click on/select any of the icons present in a visualization gallery panel 541 on the right hand side of the screen in order to switch between different visualization types, including, for example, from a grid to another type of visualization such as a bar chart. For example, in FIG. 12, the grid in the grid container 504 has been changed to a visualization. The previously set selector (see FIG. 11) is then unset because visualizations cannot support multiple selections. Indeed, the visualization in data container 504 has been reset to include data only with respect to the “Month” attribute, and only the “Month attribute” is highlighted in the attribute/metric selector 522. When the selector is reset (or unset) the targeted visualization(s) will automatically return to display the original objects with which it was designed. In FIG. 13, the user has targeted both grids and visualizations. Thus, since visualizations do not support multiple selections, in the format panel 532, the “Allow multiple selections” option is disabled. The user is able to hover the cursor over the “Allow multiple selections” option to see a tooltip that explains why the “Allow multiple selections” option is disabled.

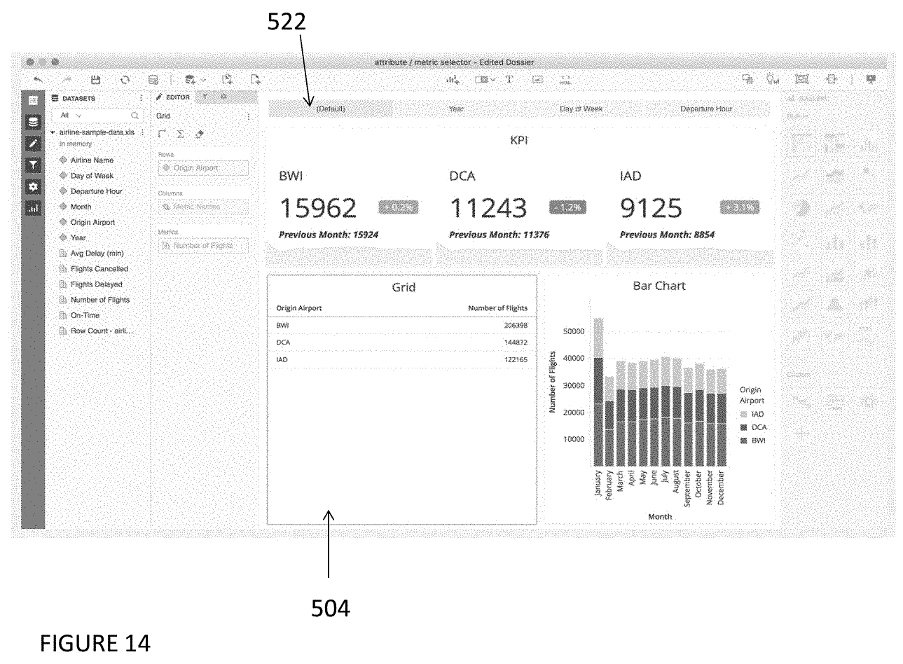

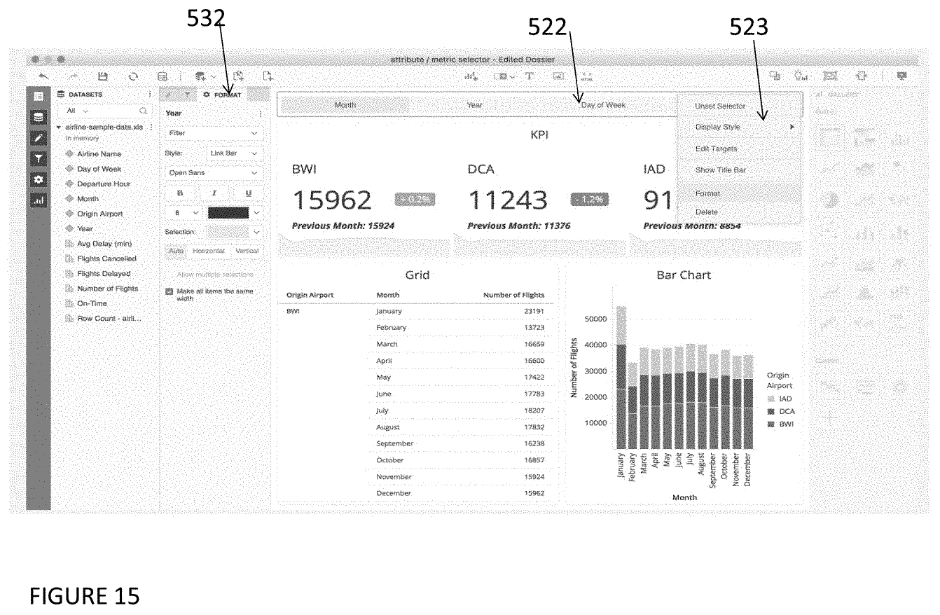

As is illustrated in FIG. 14, if the user removes the target object (e.g., “Month”) from the visualization, the visualization, itself, would still remain targeted. That is, in FIG. 14, the grid container 504 is still targeted, but the attribute “Month” is removed from both the grid container 504 and the attribute/metric selector 522 As illustrated in FIG. 15, to select another target(s), the user must access a drop down menu 523 from the attribute/metric selector 522 and select the “Edit Target” option, which will change the format panel 532 back to the editor panel 514. Each option in the drop down menu has a corresponding panel, which will replace the existing panel (e.g., the editor panel 514 or the format panel 532). Again, the potential targets will be highlighted, as illustrated in FIG. 8. The editor panel 514 includes an “Edit Targets” button 534, which the user can select to edit targets in the page. Additionally, the editor panel 514 includes an eraser icon 536, which the user can select to change the selector type. The eraser icon 536 is used to remove all data in the selector.

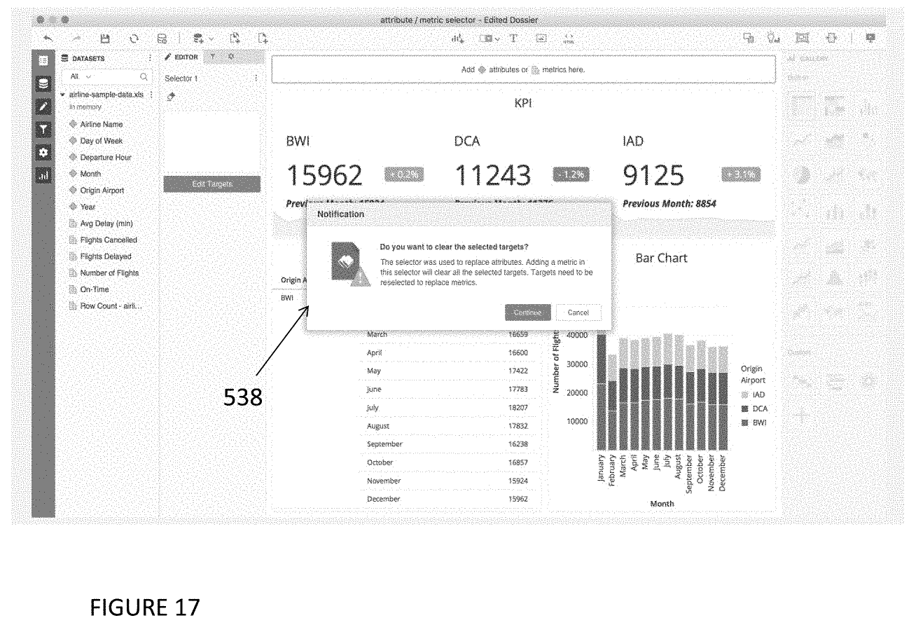

In the event that a user attempts to remove all attributes from the selector, and later add metrics to the selector, a warning message is displayed to the user. For example, in FIG. 17, a warning message 538 is displayed to the user, which indicates, for example: “The selector was used to replace attributes. Adding a metric in this selector will clear all the selected targets. Targets need to be reselected to replace metrics.”

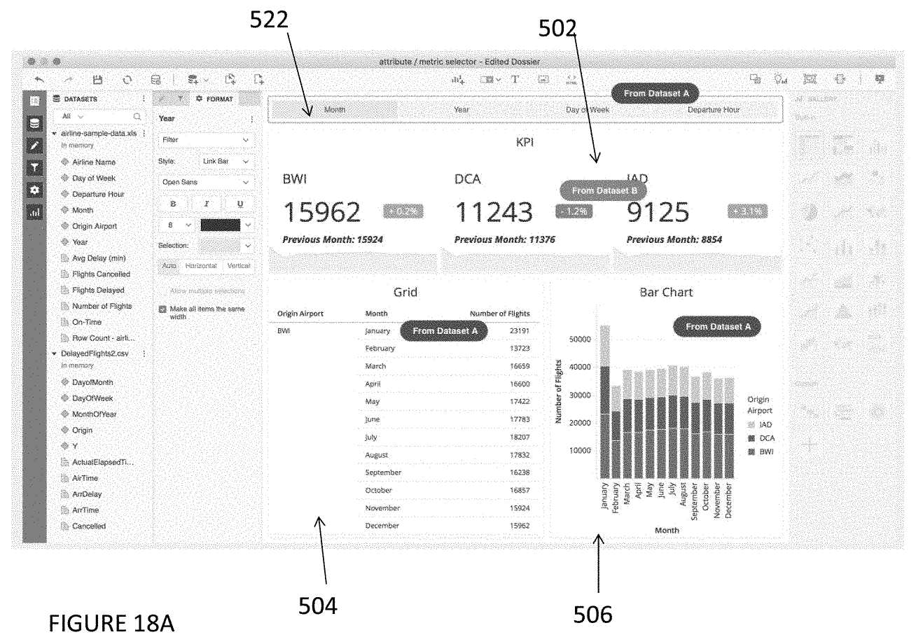

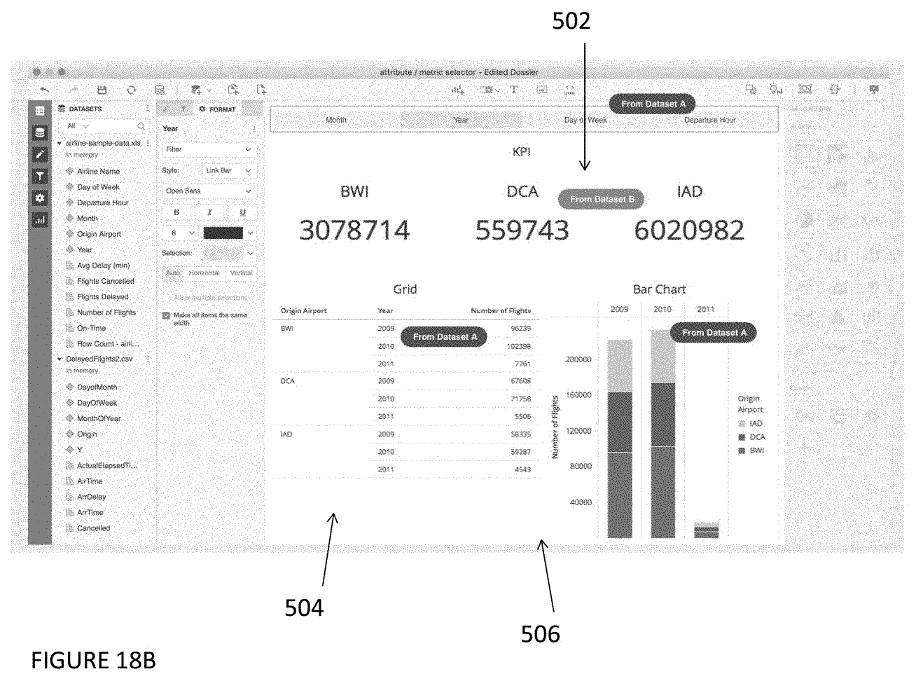

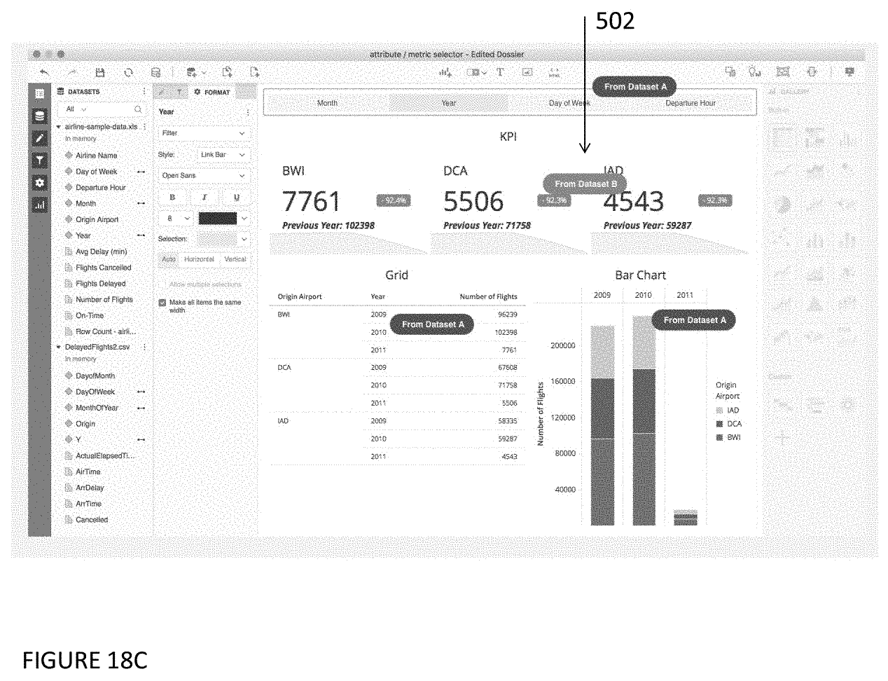

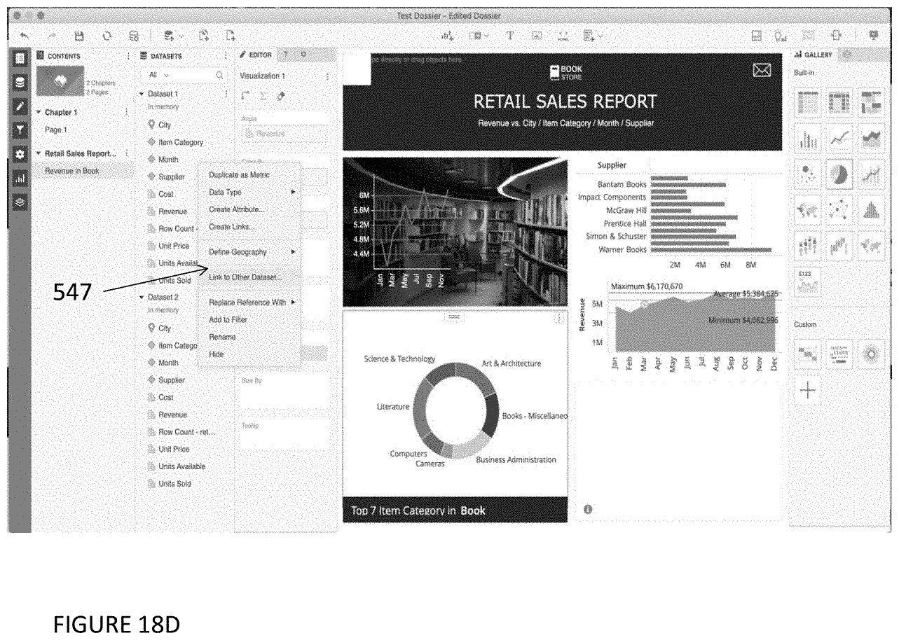

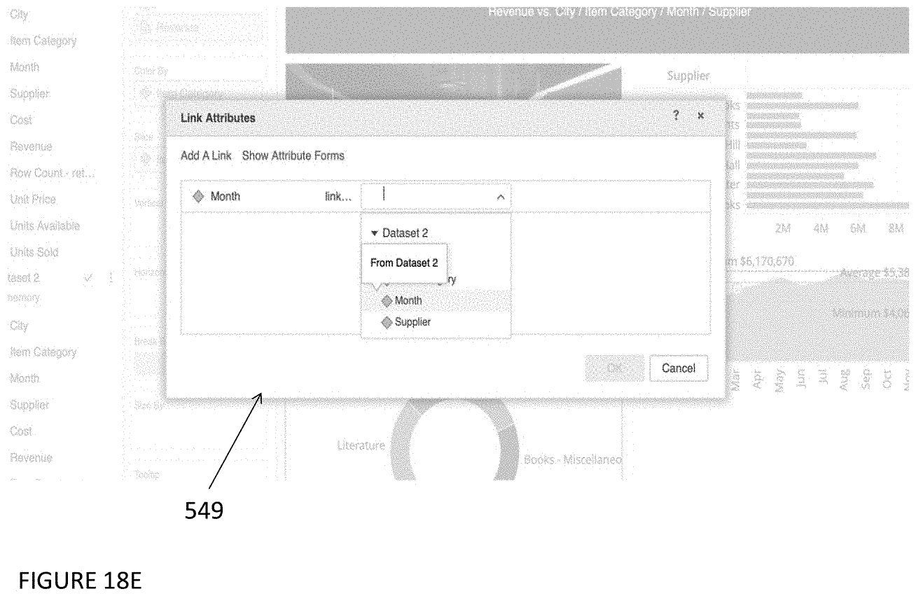

The data containers in one page may be created from different datasets. For example, as is illustrated in FIG. 18A, the grid container 504 and the bar chart container 506 are created using data from a dataset A, while the KPI container 502 is created using data from a dataset B. As illustrated in the attribute/metric selector 522, the selected attribute is initially “Month.” As is illustrated in FIG. 18B, if the user replaces the attribute “Month” with the attribute “Year,” then the KPI container 502 might not show a trend because it cannot recognize the attribute “Year” from dataset A. If, however, the user links the datasets, then the selector can be used to control the KPI container 502 as well. That is, as is illustrated in FIG. 18C, the KPI container 502 will also display the trend for “Previous Year,” when the attribute is changed from “Month” to “Year.” Datasets can be linked by linking attributes that effectively represent the same data in different datasets. To do this, as is illustrated in FIG. 18D, the user can right click on one of the attributes to link and select the “Link to other dataset” option 547 from the context menu. The system will then provide a “Link Attributes” window 549, which will allow the user to select a desired dataset to link.

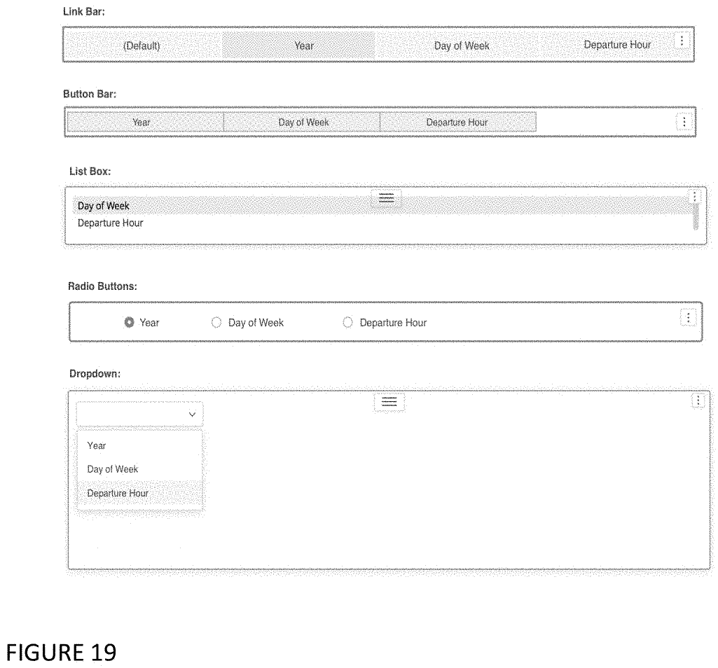

Finally, FIG. 19 illustrates several styles for the attribute/metric selectors. For example, the attribute/metric selectors may be displayed as a link bar, a button bar, a list box, radio buttons or a drop down menu. Please note that this list of styles is merely an exemplary, non-limiting list of examples and any suitable style may be used.

Accordingly, the present invention provides a report building system and method for business analytics that provides an opportunity for a more dynamic analysis and expanding the use cases for dossiers.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method, comprising:
retrieving a dataset from a database;
creating a report including a representation of the dataset, the representation of the dataset including a data attribute and a data metric;
displaying the report on a graphical user interface; and
providing a configurable selector adapted to adjust the attribute or the metric.

2. The method according to claim 1, wherein the representation of the dataset is one of a plurality of representations in the report.

3. The method according to claim 2, wherein the plurality of representations includes a grid representation and a visualization representation.

4. The method according to claim 3, wherein the selector comprises:
a replace-type selector configured to replace the data attribute or the data metric with a new data attribute or a new data metric; or
a multi-type selector configured to add an additional data attribute or an additional data metric to the data attribute or the data metric,
wherein the replace-type selector is configured to be used with the grid representation and the visualization representation and the multi-type selector is configured to be used with only the grid representation.

5. The method according to claim 1, wherein the selector comprises:
a replace-type selector configured to replace the data attribute or the data metric with a new data attribute or a new data metric; or
a multi-type selector configured to add an additional data attribute or an additional data metric to the data attribute or the data metric.

6. The method according to claim 6, wherein the replace-type selector is configured with a single selection from n attributes or n metrics to replace a single specific target in the grid representation or the visualization representation.

7. The method according to claim 6, multi-type selector is configured with any combination of n attributes or n metrics to be included in the grid representation.

8. The method according to claim 2, wherein the configurable selector is adapted to selectively adjust the attribute or the metric in one or all of the plurality of representations in the report.

9. The method according to claim 2, further comprising selecting one or all of the plurality of representations in the report as a target to be edited.

10. A non-transitory computer processor-readable storage medium storing instructions configured for execution by a computer for:
retrieving a dataset from a database;
creating a report including a representation of the dataset, the representation of the dataset including a data attribute and a data metric;
displaying the report on a graphical user interface; and
providing a configurable selector adapted to adjust the attribute or the metric.

11. A system, comprising:
a database storing a dataset;
a processor configured to:
create a report including a representation of the dataset, the representation of the dataset including a data attribute and a data metric; and
provide a configurable selector adapted to adjust the attribute or the metric; and
a graphical user interface configured to display the report.
